(19) United States
(12) Patent Application Publication
(10) Pub. No.: US 2006/0060772 A1
(43) Pub. Date: Mar. 23, 2006

(54) Distributive mass spectrometry

(76) Inventors: Dean Vinson Davis, Bartlesville, OK (US); Wayne Vincent Rimkus, Bee Cave, TX (US); James Michael Meyer, Bartlesville, OK (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/224,546

(22) Filed: Sep. 12, 2005

Related U.S. Application Data
(60) Provisional application No. 60/610,891, filed on Sep. 17, 2004.

(51) Int. Cl. H01J 49/00

(52) U.S. Cl. 250/288

(57) ABSTRACT

A system, method, and device for providing remote mass spectrometry are disclosed. The exemplary system may have an ion source for injecting ions and a measurement chamber. The measurement chamber may be coupled to the ion source for receiving and detecting signals of the ions. The measurement chamber may have an analysis cell, a magnet and an ionizing device. A control board may be in communication with the measurement chamber. The control board may receive signals received and detected by the measurement chamber. The control board may be located remotely and may have a processor for analyzing the signal.

### CROSS REFERENCE TO RELATED APPLICATIONS

This application is related to US Provisional Patent Application No. 60/610,891 filed Sep. 17, 2004 entitled Distributed Mass Spectrometry, which is incorporated fully herein by reference.

### TECHNICAL FIELD

The present invention relates to distributive mass spectrometry and more particularly, to a device, method, and system for locating components of a mass spectrometry system remotely.

### BACKGROUND INFORMATION

Mass spectrometry allows for the quantization of atoms or molecules for determining chemical and structural information about molecules. Mass spectrometers use the difference in mass-to-charge ratio (m/e) of ionized atoms or molecules to identify the atom or molecule. Molecules have distinctive fragmentation patterns that provide structural information to identify structural components. Mass spectrometers are used in industry and academia for both routine and research purposes. Mass spectrometry has a wide range of applications in the biological, the chemical, and the physical sciences.

The general operation of a mass spectrometer can be broken down into three steps. The first step involves creating gas-phase ions. The second step separates the ions in space or time based on their mass-to-charge ratio. The third step measures the quantity of ions of each mass-to-charge ratio. By performing a Fourier transformation the time domain measurements are converted to a frequency domain. The ion separation power of a mass spectrometer is described by the resolution, which is defined as: R=m/delta m, where m is the ion mass and delta m is the difference in mass between two resolvable peaks in a mass spectrum.

The sample is injected into a measurement chamber along a magnetic axis. The sample is exposed to a high-energy electron beam while contained by the magnetic field and two positively charged plates. Excitation plates give the ions a radio frequency pulse, which boosts the ions into larger orbits. The frequency of these orbits for each different ion is proportional to its mass divided by its charge. These orbiting ions create a complex radio emission that is the sum of all of the various ion frequencies. Two receiver plates detect this time-domain signal. A Fourier transform is performed on the signal yielding a frequency spectrum.

As mass spectrometry has evolved the components have been located within close proximity of each other. In the Quantra system, manufactured by Siemens Applied Automation of Bartlesville, OK, the ionization source, vacuum pump system, measurement chamber and control boards are located within a single housing (cabinet). Mass spectrometers are often designed to be within a single housing in order to reduce the overall size of the equipment and to allow for transportability.

Some applications may benefit from separating the administrator from the measurement chamber. For example, when analyzing hazardous material, current mass spectrometers require the administrator to wear protective gear. In addition, some applications may analyze material that may produce electro-magnetic waves. These electro-magnetic waves may interfere with the circuitry of the control boards. Accordingly, a need exists for a device, method, and system that provide components of a mass spectrometry system remotely.

### SUMMARY

The present invention is a novel device, system, and method for providing remote mass spectrometry. The exemplary system may have an ion source for injecting ions and a measurement chamber. The measurement chamber may be coupled to the ion source for receiving and detecting signals of the ions. The measurement chamber may have an analysis cell, a magnet, and an ionizing device. A control board may be in communication with the measurement chamber. The control board may receive signals received and detected by the measurement chamber. The control board may be located remotely and have a processor for analyzing the signal.

The invention may include the following embodiments. The ion source may be located remotely and inject ions through a conduit in communication with the measurement chamber. The vacuum system may be controlled remotely by the control board. The measurement chamber may also have a filter portion for filtering the received and detected signal. The control board may be in communication with a computer control and display system. An amplifier may be in communication with and located between the measurement chamber and control board. The control board may be located more than three feet away from the measurement chamber. The control board and ion source may be located remotely from the measurement chamber within a remote movable housing. The measurement chamber may be located in a local movable housing coupled via a conduit and communication lines to the remote movable housing.

It is important to note that the present invention is not intended to be limited to a system or method which must satisfy one or more of any stated objects or features of the invention. It is also important to note that the present invention is not limited to the exemplary embodiments described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings herein:

FIG. 1 is a block diagram of a mass spectrometry system with a control board located remotely according to the exemplary control board embodiment 100 of the present invention.

FIG. 2 is a block diagram of a mass spectrometry system with a control board located remotely according to a second exemplary control board embodiment 200 of the present invention.

FIG. 3 is a flow chart illustrating a mass spectrometry method with a control board located remotely according to an exemplary control board method embodiment 300 of the present invention.

FIG. 4 is a block diagram of a mass spectrometry system with a vacuum system located remotely according to an exemplary vacuum system embodiment 400 of the present invention.

FIG. 5 is a block diagram of a mass spectrometry system with a sample supply located remotely according to an exemplary sample supply embodiment 500 of the present invention.

### DETAILED DESCRIPTION

The present invention provides for a distributed approach to mass spectrometry. In particular, the present invention allows for minimizing space/weight in order to achieve a more compact on-site unit. The present invention also allows the administrator to conduct the mass spectrometry remotely. According to an exemplary embodiment, the control boards may be separated from the measurement chamber, vacuum system and ion source. In doing so, the measuring unit minimizes weight and volume.

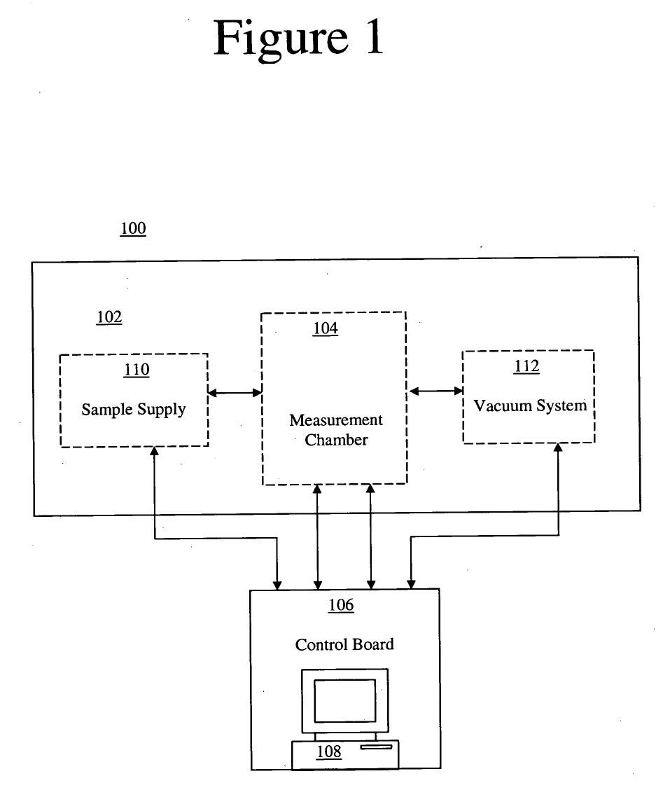

Referring to FIG. 1, an exemplary control board embodiment 100 provides for local housing 102 that holds measurement chamber 104. Control board 106 is located remotely from local housing 102. Measurement chamber 104 may include an pumping device that may be used to evacuate the measurement chamber. (not shown). For example, the pumping device may be an internal 6.5 KV Ion pump or any other suitable pump to achieve a nominal 10⁻¹⁰ Torr I/s. More particularly, the ionizing device may be a high-energy beam that ionizes samples and creates molecular fragments of predictable patterns that indicate the type of compounds present in the sample and the relative amounts of such compounds. Within measurement chamber 104 a permanent Magnet may also be housed (not shown), for example, a 1-Tesla (nominal) permanent magnet, and such magnet may be used to generate a magnetic field. Measurement chamber 104 may also include an analyzer cell (not shown) where measurement data of an ionized sample may be collected. The measurement data may be collected by receiver plates (not shown) located within the analyzer cell. After collecting measurement data, the receiver plates may transmit a measurement data signal outside measurement chamber 104 and local housing 102 to control board 106.

According to the above exemplary embodiment, local housing 102 may also house a sample supply 110 and vacuum system 112. Sample supply 110 provides sample material to measurement chamber 104 in gaseous form. The environmental conditions of sample supply 110 are regulated so as to provide the sample material in a gaseous form. Stainless steel piping or other suitable material acts as a conduit to supply the gaseous sample to measurement chamber 104. A valve or other suitable flow control mechanism is controlled by control board 106 and is periodically opened to allow for a controlled flow of gaseous sample material to enter measurement chamber 104 for ionization. Sample supply. 110 may also include filters and other equipment necessary in order to provide a clean and pure gaseous sample to measurement chamber 104. Vacuum system 112 supplies a vacuum to maintain the necessary conditions of the sample material during the testing and analyzing process.

The control board 106 receives the measurement data signal from the receiver plates and processes the signal. Control board 106 may include multiple circuit boards. Control board 106 may include a back plane in order to accept and provide connections to multiple circuit boards. One exemplary circuit board may include a 6-layer, 64 megabit CPU board, with a CPU. An example of such a CPU may be a Triton II HX chipsets and enhanced I/O chipset manufactured by Intel®. Other circuit boards may include a network interface card, a waveform generator, a digital signal processor, and one or more analog data input boards. In operation, the waveform generator board may perform waveform generation and data acquisition functions. The digital signal processor may be used to assist in the processing of the measurement data signal. For example, the digital signal processor may be the Hawk-81, a Momentum Data Systems Digital Signal Processor (DSP) board for the ISA bus and a Modular Analog Front End (MAFE) daughter board. One illustrative configuration may include a MAFE with an AD-1847 stereo codex. In operation, the Hawk-81 uses a MAFE to access the external analog measurement data signal and digitizes the signal. The analog boards-monitor, control, and generate drive signals for the various components of the mass spectrometer.

Control board 106 transmits control signals to measurement chamber 104 to allow an administrator to control the various components of the mass spectrometer. Control board 106 may also allow the administrator to monitor conditions in measurement chamber 104. Sensors located within measurement chamber 104 may relay data to control board 106 via communication lines. Such communication lines may be hardwired (e.g., copper wire, fiber optic, etc.) or may be wireless (e.g., radio frequency). Control board 106 may automatically, based on preprogrammed parameters or commands provided by the administrator, make adjustments to valves, actuators, or other various components of the mass spectrometer. Such control signals may be sent from control board 106 over a communication line to the mass spectrometers various components.

As shown in FIG. 1, control board 106 may be stored located remotely from local housing 102 and may be located within a separate remote housing (not shown). Control board 106 may include a variety of input and output devices to communicate with the administrator. For example, a combination of hardware and software may provide the administrator with a graphical user interface (GUI) 108 to administer the mass spectrometer process. Control board 106 may also be networked with other computers to allow remote access by other administrators or software applications.

Local housing 102 may be a cabinet with a front door to access the components of the mass spectrometer stored internally. The cabinet may be on rollers to allow the administrator to move the mass spectrometer to a testing location. Local housing 102 may include a power supply for providing power to measurement chamber 104, sample supply 110 and vacuum system 112. The components of the local housing may be connected to control board 106 via communication lines. The communication lines may include a variety of analog and digital lines of communication (e.g., copper wire, fiber optic cables, radio frequency, etc.). The control signals, sensor signals, and measurement data signals are communicated between the components of local housing 102 and control board 106 via the above-mentioned communication lines. Some or all of the signals may be multiplexed and sent over a single communication line.

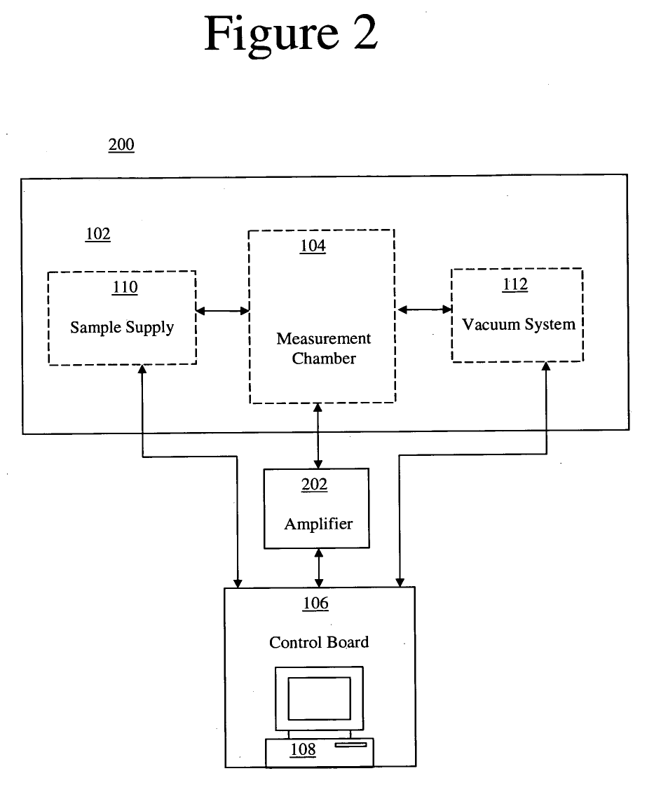

Referring to FIG. 2, a second exemplary control board embodiment 200 provides the ability to increase the distance of separation between local housing 102 and control board 106. As shown in FIG. 1 and 2, control board 106 is located remotely from the local housing 102. Measurement chamber 104, sample supply 110, and vacuum system 112 are housed within local housing 102. The details and operation of local housing 102 and its various components are described in the first exemplary control board embodiment 100, set forth above. The second exemplary control board embodiment 200 provides amplifier 202. Amplifier 202 may be used to amplify one or more of the signals sent to and from the various components of local housing 102 and control board 106. For example, the measurement data signal may be amplified to increase the allowable distance between control board 106 and local housing 102.

Amplifier 202 may include filters, buffers and other suitable signal processing components to amplify and clean the signals being transmitted. Amplifier 202 may be located at various points along transmission of the various signals. For example, amplifier 202 may be located within local housing 102. In one preferred embodiment, the measurement data signal may be cleaned and amplified prior to transmission to control board 106. Amplifier 202 may include components to convert the various signals and transmit such signals using known equipment and protocols to wirelessly transmit such signals via wireless channels of communication. For example, vacuum system 112 supplying a vacuum to measurement chamber 104 may be controlled remotely by sending control signals from control board 106. This control signal may be amplified during transmission to increase the distance from measurement chamber 104 and control board 106. It should also be noted that one skilled in the art will appreciate that a plurality of amplifiers may be incorporated in the embodiments described herein.

In other embodiments, some of the signal processing capabilities may remain in proximity to measurement chamber 104 so as to analyze, process, and store measurement data. In order to provide such local signal processing capabilities local housing 102 may further include the addition of at least a processor, a memory device, and a communications device capable of analyzing, processing, and storing measurement data along with the ability to transmit and receive signals to control board 106.

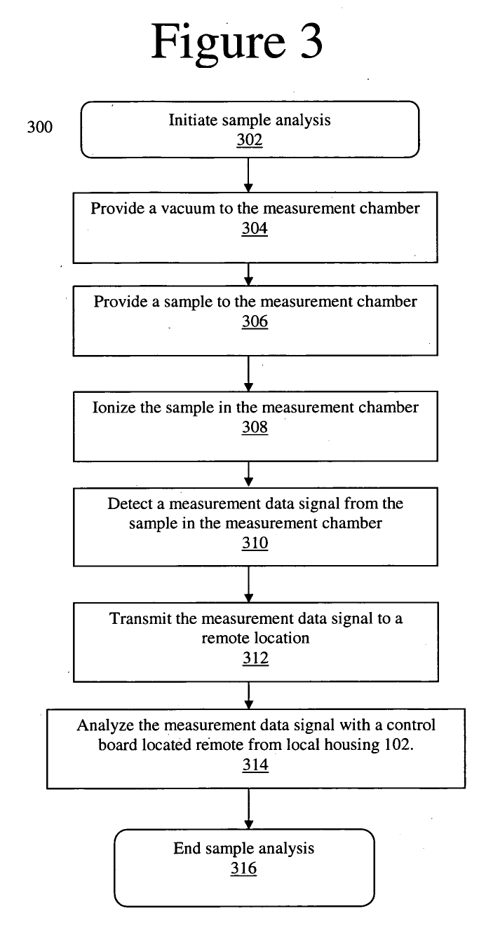

FIG. 3 shows a flow chart illustrating an exemplary control board method embodiment 300 of the present invention. The administrator initiates the sample analysis by providing instructions to control board 106 (block 302). Vacuum system 112 provides a vacuum for measurement chamber 104 (block 304). Control board 106 signals a sample supply valve located within measurement chamber 104 to open. An amount of gaseous sample is supplied to measurement chamber 104 in gas form (block 306). The sample gas is ionized in measurement chamber 104 (block 308). A measurement data signal is detected from the ionized sample (block 310).

The measurement data signal is transmitted to control board 106 located in a remote location (block 312). The measurement data signal may be transmitted using a variety of methods as set forth herein. For example, the measurement data signal may be filtered and amplified. In another example, the measurement data signal may be converted to a wireless protocol and sent via a wireless channel to control board 106. In yet another example, the measurement data signal may be transmitted in a filtered but un-amplified form to control board 106. The extent or distance to which the components of local housing 102 and control board 106 can be placed apart depends upon the cabling and transmission characteristics.

Once control board 106 receives the measurement data-signal, control board 106 may analyze the measurement data signal at a location remote to local housing 102 (block 314). Control board 106 may analyze the measurement data signal by performing a Fourier Transformation on the measurement data signal. Performing the Fourier Transformation on the measurement data signal converts the measurement data signal from a time domain signal to a frequency domain signal. The frequency domain signal may be analyzed to determine the components and structure of the sample being analyzed. Control board 106 allows the administrator to manipulate, display, and store the measurement data at a remote location. The sample testing and analysis is complete for the above sample (block 316). Measurement chamber 104 may be cleaned and/or injected with a new sample for further testing. The above exemplary method that may be used in conjunction with other exemplary methods associated with other aspects of the invention. For example, control board 106 may also transmit control signals or receive sensor signals from the components of local housing 102.

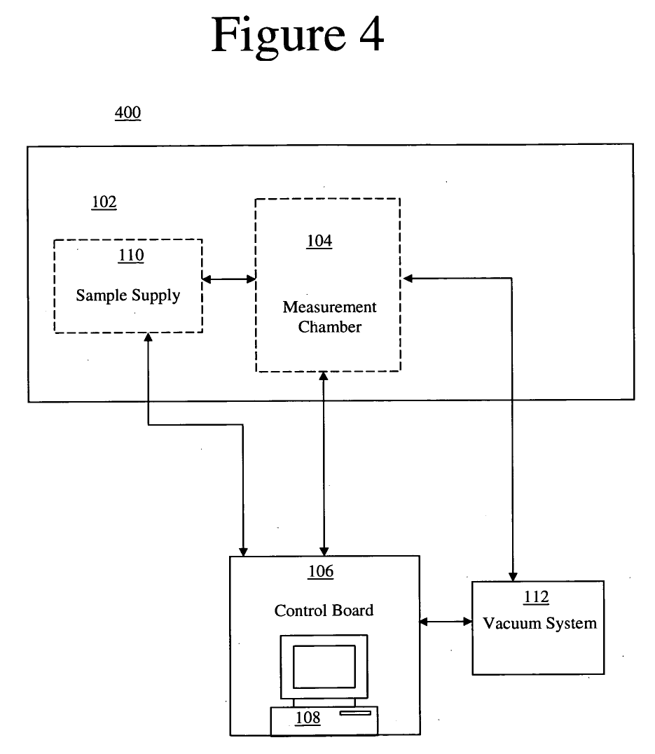

FIG. 4 shows an exemplary vacuum system embodiment 400 that provides for the ability to house vacuum system 112 and the control board 106 in a location remote from local housing 102. In this embodiment, measurement chamber 106 and sample supply 110 are housed within local housing 102. The details of the local housing and its various components are described in detail above. In this embodiment, piping, as described above, or other suitable material couples vacuum system 112 and measurement chamber 106. The size, length, strength, and other characteristics of the piping or other material depend on the desired distance of separation between vacuum system 112 and measurement chamber 106. In this embodiment, vacuum system 112 may generate a vacuum that is greater than is necessary at measurement chamber 104 to account for the distance between vacuum system 112 and measurement chamber 106. One skilled in the art will appreciate that vacuum system 112 may be located in closer proximity to measurement chamber 104 than other remotely located components. As described above, control valves located at measurement chamber 104 may be controlled by control board 106 to regulate the vacuum produced in measurement chamber 104.

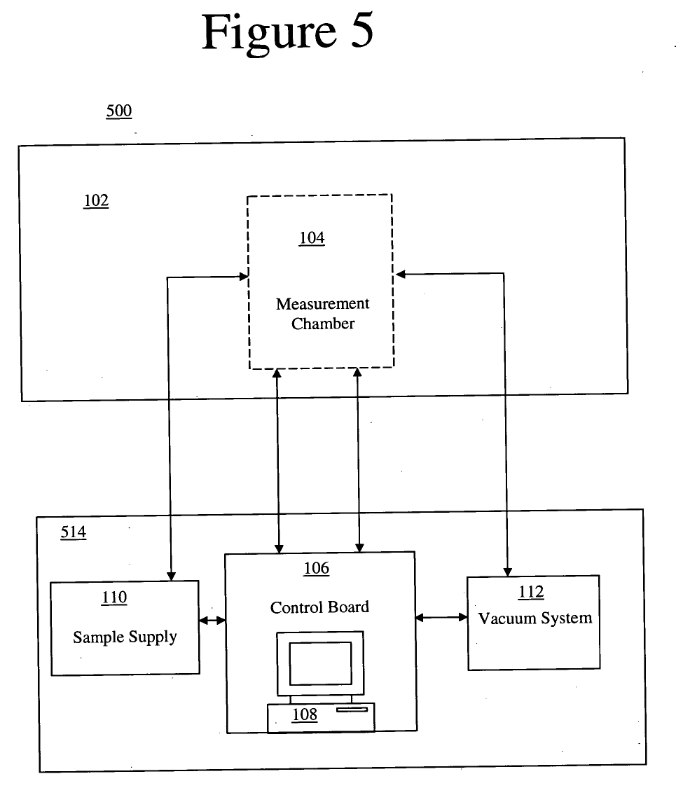

FIG. 5 shows an exemplary sample supply embodiment 500 that provides for the ability to house sample supply 110, vacuum system 112, and control board 106 in remote housing 514, which is remotely located from local housing 102. Housing sample supply 110, vacuum system 112, and control board 106 in remote housing 514 allows for a portable and small local housing 102. The details and operation of the various components set forth in this embodiment are described in detail above. In this embodiment, piping, as described above, or other suitable material couples sample supply 110 and vacuum system 112 to measurement chamber 106. The size, length, strength, and other characteristics of the piping or other material depend on the desired distance of separation between local housing 102 and remote housing 514. The environmental conditions necessary to maintain the sample in a gaseous state may also determine the characteristics of the piping used.

Thus, devices, systems, and methods that allow for distributed mass spectrometry are provided. Moreover, it will be understood that the foregoing is only illustrative of the principles of the invention, and that various modifications can be made by those skilled in the art without departing from the scope and spirit of the invention.

Persons skilled in the art will appreciate that the present invention can be practiced by other than the described embodiments, which are presented for purposes of illustration rather than of limitation, and the present invention is limited only by the claims that follow.

What is claimed is:

1. A mass spectrometer comprising:
an ion source for injecting ions;
a measurement chamber coupled to the ion source for receiving and detecting ions, wherein the measurement chamber further comprises an analysis cell, a magnet, and a pumping device;
a sample supply connected to the measurement chamber for providing a sample to the measurement chamber;
a vacuum system connected to the measurement chamber; and
a control board remotely located from the measurement chamber, the sample supply, and the vacuum chamber, wherein the control board is capable of sending and receiving signals to and from the measurement chamber, the sample supply, and the vacuum chamber, and wherein the control board includes software and circuitry for processing and analyzing signals from the measurement chamber.

2. The mass spectrometer of claim 1, wherein circuitry for processing and analyzing signals from the measurement chamber includes a network interface card, a waveform generator, a digital signal processor, and one or more analog data input boards.

3. 10. The mass spectrometer of claim 2, wherein the digital signal processor is HAWK-81 processor.

4. The mass spectrometer of claim 1, further comprising: an amplification device that amplifies the signals between the measurement chamber, the sample supply, the vacuum chamber, and the control board.

5. The mass spectrometer of claim 1, further comprising: a filter for filtering the signals between the measurement chamber, the sample supply, the vacuum chamber, and the control board.

6. The mass spectrometer of claim 1, wherein the analysis cell includes receiver plates for detecting ions.

7. The mass spectrometer of claim 1, wherein the magnet is a 1-Tesla permanent magnet.

8. The mass spectrometer of claim 1, wherein the pumping device is a 6.5 Kilovolt ion pump.

9. A mass spectrometer comprising:
an ion source for injecting ions;
a measurement chamber coupled to the ion source for receiving and detecting ions, wherein the measurement chamber further comprises an analysis cell, a magnet, and a pumping device;
a sample supply connected to the measurement chamber for providing a sample to the measurement chamber, wherein the sample supply is remotely located from the measurement chamber;
a vacuum system connected to the measurement chamber, wherein the vacuum system is remotely located from the measurement chamber; and
a control board remotely located from the measurement chamber, wherein the control board is capable of sending and receiving signals to and from the measurement chamber, the sample supply, and the vacuum chamber, and wherein the control board includes software and circuitry for processing and analyzing signals from the measurement chamber, the supply chamber, and the vacuum chamber.

10. The mass spectrometer of claim 9, wherein circuitry for processing and analyzing signals from the measurement chamber includes a network interface card, a waveform generator, a digital signal processor, and one or more analog data input boards.

11. The mass spectrometer of claim 10, wherein the digital signal processor is HAWK-81 processor.

12. The mass spectrometer of claim 9, further comprising: an amplification device that amplifies the signals between the measurement chamber and the control board.

13. The mass spectrometer of claim 9, further comprising: a filter for filtering the signals between the measurement chamber and the control board.

14. The mass spectrometer of claim 9, wherein the analysis cell includes receiver plates for detecting ions.

15. The mass spectrometer of claim 9, wherein the magnet is a 1-Tesla permanent magnet.

16. The mass spectrometer of claim 8, wherein the pumping device is a 6.5 Kilovolt ion pump.

17. A method for providing mass spectrometry, the method comprising the steps of:
providing a sample to a measurement chamber;
ionizing the sample using a magnet and an ionizing device in the measurement chamber;
providing a vacuum to the measurement chamber;
detecting measurement data signals from the sample in the measurement chamber;
transmitting the measurement data signals to a control board, wherein the control board is remotely located from the measurement chamber; and
analyzing the measurement data signals with processing circuitry located on the control board.

18. The method of claim 17, further comprising the step of: filtering the measurement data signals.

19. The method of claim 17, further comprising the step of: amplifying the measurement data signals.
